(19) United States
(12) Patent Application Publication
(10) Pub. No.: US 2004/0229052 A1
(43) Pub. Date: Nov. 18, 2004

(54) Composite material

(75) Inventors: Younger Ahluwalia, Desoto, TX (US); Matti Kiik, Richardson, TX (US); Thomas D. Karol, Dallas, TX (US)

Correspondence Address: FITZPATRICK CELLA HARPER & SCINTO, 30 ROCKEFELLER PLAZA, NEW YORK, NY, 10112, US

(73) Assignee: ElkCorp

(21) Appl. No.: 10/766,649

(22) Filed: Jan. 27, 2004

Related U.S. Application Data
(63) Continuation-in-part of application No. 10/354,216, filed on Jan. 29, 2003.
(63) Continuation-in-part of application No. 10/354,220, filed on Jan. 29, 2003.
(63) Continuation-in-part of application No. 10/354,219, filed on Jan. 29, 2003.

(51) Int. Cl. B32B 9/00

(52) U.S. Cl. 428/457; 428/689; 428/543

(57) ABSTRACT

A composite material comprising a first layer which comprises a prefabricated microcells component, surfactant-generated microcells, a surfactant component, a filler component and a binder component and a second layer, which comprises a metallic component. The composite material may further comprise a substrate to which the first layer is adhered. The composite materials have heat insulating and fire resistant characteristics and are particularly suited for use in building materials and mattresses.

### CROSS REFERENCE TO RELATED APPLICATIONS

This application is a continuation-in-part of pending U.S. application Ser. No. 10/354,216, filed on Jan. 29, 2003, which claims priority under 35 U.S.C. §119(e) to Provisional Application No. 60/352,691; of pending U.S. application Ser. No. 10/354,220, filed on Jan. 29, 2003, which claims priority under 35 U.S.C. §119(e) to Provisional Application No. 60/352,692; of pending U.S. application Ser. No. 10/354,219, which claims priority under 35 U.S.C. §119(e) to Provisional Application No. 60/352,693; of pending U.S. application Ser. No. 09/663,255 filed on Sep. 15, 2000, which claims priority under 35 U.S.C. §19(e) to Provisional Application No. 60/168,057, filed Nov. 30, 1999; and of pending U.S. application Ser. No. 09/955,395 filed on Sep. 18, 2001.

### FIELD OF THE INVENTION

This invention relates to composite materials and to articles comprising the composite materials which may be used in building materials, motor vehicles, heaters, dryers, mattresses, draperies, furniture upholstery, and the like. The invention further relates to articles of manufacture that utilize the composite materials of the invention, e.g. building materials and mattresses.

### BACKGROUND OF THE INVENTION

Various attempts have been made to produce heat insulating, fire resistant structural materials and fabrics having characteristics that make them suitable for use in building materials, clothing, motor vehicles, mattresses and in other applications.

U.S. Pat. No. 5,540,980 is directed to a fire resistant fabric useful for mattress ticking. The fabric is formed from a corespun yarn comprising a high temperature resistant continuous filament fiberglass core and a low temperature resistant staple fiber sheath, which surrounds the core. The fiberglass core comprises about 20% to 40% of the total weight of the corespun yarn while the sheath comprises about 80% to about 60% of the total weight of the corespun yarn. The corespun yarn can be woven or knit to form fabric with fire resistant characteristics. When exposed to a flame, the sheath chars and the fiberglass core serves as a fire barrier. In a preferred embodiment, the sheath is made from cotton.

U.S. Pat. No. 5,091,243 discloses a fire barrier fabric comprising a substrate formed of corespun yarns and a coating carried by one surface of the substrate. Other fire resistant fabrics include Fenix™ (Milliken, LaGrange, Ga.) and fabrics made by Freudenberg (Lowell, Mass.), Ventex Inc. (Great Falls, Va.), BASF, Basofil Fiber Division (Enka, N.C.), Carpenter Co. (Richmond, Va.), Legget and Platt (Nashville, Tenn.), Chiquala Industries Products Group (Kingspoint, Tenn.), and Sandel (Amsterdam, N.Y.). DuPont also manufacturers a fabric made from Kevlar™ thread. In addition, the mattress industry has attempted to manufacture mattresses by using Kevlar™ thread, glass thread, flame retardant polyurethane foams, flame retardant ticking, flame retardant cotton cushioning and flame retardant tape. However, use of these materials adds to the cost of mattresses and may result in a cost-prohibitive product. Additionally, some fire-resistant threads, such as glass threads, are difficult to work with and can break, adding to the time required for manufacturing the mattress, which also translates into added costs.

Flame retardant tapes are also difficult to work with and increase production time. In addition, flame retardant tapes are only available in a limited number of colors and sizes. Flame retardant polyurethanes may release noxious gases when they smolder and ignite. Furthermore, the process for flame retarding ticking often compromises the desired characteristics of the ticking (e.g. it may no longer be soft, drapable, pliable, flexible, etc).

For many years substrates such as fiberglass have been coated with various compositions to produce materials having utility in, among other applications, the building industry. U.S. Pat. No. 5,001,005 relates to structural laminates made with facing sheets. The laminates described in that patent include thermosetting plastic foam and have planar facing sheets comprising 60% to 90% by weight glass fibers (exclusive of glass micro-fibers), 10% to 40% by weight non-glass filler material and 1% to 30% by weight non-asphaltic binder material. The filler materials are indicated as being clay, mica, talc, limestone (calcium carbonate), gypsum (calcium sulfate), aluminum trihydrate (ATH), antimony trioxide, cellulose fibers, plastic polymer fibers or a combination of any two or more of those substances. The patent further notes that the filler materials are bonded to the glass fibers using binders such as urea-, phenol- or melamine-formaldehyde resins (UF, PF, and MF resins), or a modified acrylic or polyester resin. Ordinary polymer latexes used according to the disclosure are Styrene-Butadiene-Rubber (SBR), Ethylene-Vinyl-Chloride (EVCl), PolyVinylidene Chloride (PvdC), modified PolyVinyl Chloride (PVC), PolyVinyl Alcohol (PVOH), and PolyVinyl Acetate (PVA). The glass fibers, non-glass filler material and non-asphaltic binder are all mixed together to form the facer sheets.

U.S. Pat. No. 4,745,032 discloses an acrylic coating comprised of one acrylic underlying resin, which includes fly ash and an overlying acrylic resin, which differs from the underlying resin.

U.S. Pat. No. 4,229,329 discloses a fire retardant coating composition comprising fly ash and vinyl acrylic polymer emulsion. The fly ash is 24 to 50% of the composition. The composition may also preferably contain one or more of a dispersant, a defoamer, a plasticizer, a thickener, a drying agent, a preservative, a fungicide and an ingredient to control the pH of the composition and thereby inhibit corrosion of any metal surface to which the composition is applied.

U.S. Pat. No. 4,784,897 discloses a cover layer material on a basis of a matting or fabric, which is especially for the production of gypsum boards and polyurethane hard foam boards. The cover layer material has a coating on one side, which comprises 70% to 94% powdered inorganic material, such as calcium carbonate, and 6% to 30% binder. In addition, thickening agents and cross-linking agents are added and a high-density matting is used.

U.S. Pat. No. 4,495,238 discloses a fire resistant thermal insulating composite structure comprised of a mixture of from about 50% to 94% by weight of inorganic microfibers, particularly glass, and about 50% to 6% by weight of heat resistant binding agent.

U.S. Pat. No. 5,965,257, issued to the present assignee, the entire disclosure of which is incorporated herein by reference, discloses a structural article having a coating which includes only two major constituents, while eliminating the need for viscosity modifiers, for stabilizers or for blowing. The structural article of U.S. Pat. No. 5,965,257 is made by coating a substrate having an ionic charge with a coating having essentially the same iconic charge. The coating consists essentially of a filler material and a binder material. The assignee, Elk Corporation of Dallas, produces a product in accordance with the invention of U.S. Pat. No. 5,965,257 which is marketed as VersaShield®.

As indicated in U.S. Pat. No. 5,965,257, VersaShield® has a variety uses. However, it has been found that the products made in accordance with U.S. Pat. No. 5,965,257 are not satisfactory for certain uses because they lack sufficient drapability.

U.S. patent application Ser. No. 09/955,395, filed on Sep. 18, 2001, also assigned to the present assignee, the entire disclosure of which is incorporated herein by reference, addresses these inadequacies with a fire resistant fabric material comprising a substrate having an ionic charge coated with a coating having essentially the same ionic charge wherein the coating comprises a filler component which includes clay and a binder component. The fire resistant fabric material thus produced has satisfactory flexibility, pliability and drapability characteristics. However, while this material is suitable as a fire resistant fabric material, it is desirable to provide a fire resistant material that would also have cushioning or “bounce back” characteristics.

U.S. Pat. No. 6,228,497 teaches a fire resistant glass fiber which is made by mixing together glass fibers, a binder and calcium carbonate. In addition, clay may be added to improve fire resistance.

U.S. Pat. No. 4,994,317 teaches a multilayered fire resistant material which comprises a flame durable textile fabric substrate, a flexible silicone polymer layer, and a heat reflective paint. Clay may be added to the silicone layer to enhance flame resistance.

GB 2167060 teaches a fire resistant material comprising synthetic mineral fibers (including glass wool), clay and a binder. The fire resistant material is made by combining the components. The binder is preferably starch or modified starch; condensates of phenol, urea, melamine, resorcinol, tannin with aldehyde, isocyanates, reactive cements; binders formed in situ by inter-reaction between silica and calcium; hydraulic cements; and potassium and sodium silicates.

U.S. patent application Ser. No. 10/354,216, filed on Jan. 29, 2003, which this application claims priority to as a continuation-in-part, relates to fire resistant structural materials and to fire resistant fabric materials made therefrom. The structural materials comprise a surfactant component, surfactant generated microcells, a filler component and a binder component. The structural material is fire resistant. The structural material may be used to coat a substrate to make fire resistant fabric materials.

U.S. patent application Ser. No. 10/354,220, filed on Jan. 29, 2003, which this application claims priority to as a continuation-in-part, relates a structural material comprising a prefabricated microcell component, a surfactant component, to a surfactant-generated microcell component, a filler component and a binder component. The prefabricated microcell component is essentially a hollow sphere or a component capable of forming a hollow sphere that has been constructed or manufactured before being employed in the structural material. The structural material may be used to coat a substrate to make a fire resistant fabric material.

U.S. patent application Ser. No. 10/354,219, filed on Jan. 29, 2003, which this application claims priority to as a continuation-in-part, relates to a structural material comprising a surfactant component, surfactant-generated microcells, a gel catalyst component and a binder component. The structural material may further comprise a filler component. The structural material may be used to coat a substrate to make a fire resistant fabric material.

However, while these materials may be suitable as fire resistant fabric materials, it is desirable to provide a fire resistant material that would also have cushioning or “bounce back” characteristics and have heat-insulating properties.

### SUMMARY OF THE INVENTION

The present invention relates to a composite material comprising a first layer comprising a prefabricated microcell component, a surfactant component, surfactant-generated microcells, a filler component and a binder component, and a second layer comprising a metallic component. The composite material is usefil, inter alia, for making heat insulating and fire resistant articles of manufacture. The composite material may further include a substrate to which the first layer is adhered to provide a coated substrate. The substrate may be planar and the first layer may be adhered to one or both sides of the substrate. The second layer may be adhered to one or both first layer surfaces or to the substrate directly. If no substrate is employed and if the first layer is planar, then the second layer may be adhered to one or both sides of the first layer. The composite materials may further include a water repellent material, an antifungal material, an antibacterial material, a surface friction agent, a flame retardant material and/or an algaecide. Further, the composite materials may be colored with dye. In its simplest embodiment, the composite material of the present invention consists essentially of a first layer consisting essentially of a prefabricated microcells component, a filler component and a binder component, and a second layer consisting essentially of a metallic component. The metallic component may be any metallic component known in the art capable of imparting heat-insulating properties. In a preferred embodiment, the metallic component is aluminum foil.

The composite materials of the present invention may be employed to make heat insulating, fire resistant building materials. In such an embodiment, the composite materials of the present invention may be adhered to building materials, such as gypsum boards and siding materials, including sheathing. The building materials may be prepared during the building material making process to include the composite materials of the present invention or the composite materials may be utilized after the building materials have already been installed.

In a particularly preferred embodiment, the first layer does not bleed through the substrate during the material making process. The substrate may be any suitable reinforcement material capable of withstanding processing temperatures and is preferably woven fiberglass. The binder component is preferably acrylic latex and the filler preferably comprises clay. The prefabricated microcell component is preferably a hollow sphere or a component capable of forming a hollow sphere that has been constructed or manufactured before being employed in the present invention. In a preferred embodiment, the prefabricated microcell component is ceramic microspheres.

application Ser. No. 09/955,395, filed on Sep. 18, 2001 discloses a fire resistant fabric material comprised of a coated substrate wherein the coating and the substrate have essentially the same ionic charge. The coating is comprised of a filler, including clay, and a binder. The coating does not bleed through the substrate because the ionic charges of the coating and the substrate, which are essentially the same, repel each other. In at least one embodiment, the filler component of the coating may include ceramic microspheres in addition to clay and perhaps other filler constituents. Although ceramic microspheres bear no charge, the resulting coating has essentially the same ionic charge as the substrate due to the charges associated with the clay, the binder and perhaps the other filler constituents.

The present invention also features clay and ceramic microspheres as filler constituents, but the coatings of the present invention differ from those described in application Ser. No. 09/955,395. In the present invention, the relative amount of ceramic microspheres included in the filler component of the coating may be increased such that the coating and the substrate do not have essentially the same ionic charge. Bleed through is avoided in the present invention either because the diameters of the microspheres forming the microcells are greater than the diameter of the holes in the substrate, or because viscosity modifiers have been added or air has been introduced to increase viscosity. Moreover, the structural materials of the present invention include a metallic component, which surprisingly imparts heat-insulating properties to the material.

### DETAILED DESCRIPTION

The composite material of the invention, comprises a first layer, which comprises a prefabricated microcell component, a surfactant component, a surfactant-generated microcell component, a filler component and a binder component, and a second layer which comprises a metallic component. As used herein, a prefabricated microcell component is essentially a hollow sphere or a component capable of forming a hollow sphere that has been constructed or manufactured before being employed in the present invention. The prefabricated microspheres are generally made from plastic, polymer, ceramic or glass, acrylic and styrene. As used herein, surfactant-generated microcells are essentially voids or hollow spheres which are formed by the presence of a surfactant during the composite material making process. Thus, the surfactant components of the present invention are capable of forming microcells. The prefabricated and surfactant-generated microcells may impart various characteristics to the fire resistant materials of the present invention, including, inter alia, improved fire resistance, flexibility, pliability, drapability, and “bounce back”. The metallic component may be any metallic component known in the art capable of imparting heat insulating properties, including, but not limited to, aluminum, and stainless steel. The metallic component may be a metal film or foil, or it may be sprayed onto the first layer or onto the substrate and then heat dried in an oven. In a preferred embodiment, the metallic component is aluminum foil.

In accordance with the invention, a composite material may be made by adhering the first layer to one or both sides of a substrate to provide a coated substrate. The second layer may be adhered to the first layer surfaces or to the substrate directly. If no substrate is employed and if the first layer is planar, then the second layer may be adhered to one or both sides of the first layer. In a preferred embodiment, the first layer does not bleed through the substrate during the material making process. In its simplest embodiment, the structural material of the present invention consists essentially of a first layer comprising a prefabricated microcells component, a filler component and a binder component, and a second layer comprising a metallic component. As used herein, the term “coated substrate” means a material wherein at least a part of the substrate is coated with the coating.

The filler material of the present invention preferably includes clay. The clay is preferably China clay which is very soft and light. Alternatively, the clay may be Paragon™, which is also a soft clay (i.e. it is soft to the touch), Suprex™, which is a hard clay (i.e. it is hard to the touch), Suprex™ amino silane treated clay, which is used for crosslinking because it will chemically bond with binder, and for highloading, Ballclay™, which has elastic properties (i.e. it feels rubbery), Texwhite 185 (available from Huber, Dry Branch, Ga.), and ECC 1201 (available from Huber). All of above-listed clay products, unless otherwise noted, are available, for example, from Kentucky-Tennessee Clay Company of Langley, S.C. In one embodiment, the clay is Ballclay™ 3380 which is particularly inexpensive compared to other clays. In a preferred embodiment, the clay is Kaolin clay which is a lower grade China clay. In particularly preferred embodiments, the clay is Texwhite 185 or ECC 1201.

In the present invention, clay is a preferred filler because of its elongation properties (it has a low modulus), its abrasion resistance, its tear resistance, and its tensile strength. Moreover, clay is a good heat barrier; it does not disintegrate when an open flame (temperature≧1500° F.) is applied directly to a coating of the present invention that includes clay. In addition, clay provides a slick, elastic, glassy surface which exhibits flexibility. Furthermore, as noted, clay is inexpensive and thus can help to keep the cost of the fabric material low.

In another preferred embodiment, the filler includes the flame retardant FRD-004 (decabromodiphenyloxide; Tiarco Chemicals, Dalton, Ga.).

The filler material may alternatively or additionally comprise a filler selected from the group consisting of decabromodiphenyloxide, antimony trioxide, calcium carbonate, charged calcium carbonate, titanium dioxide, fly ash (such as Alsil O4TR™ class F fly ash produced by JTM Industries, Inc. of Martin Lake and Jewett, Tex. which has a particle size such that less than 0.03% remains on an agitated 0.1 inch X 0.1 inch screen), and 3-X mineralite mica (available from Engelhard, Inc. of Louisville, Ky.), or any mixture of these filler materials to meet desired cost and weight criteria. Calcium carbonate may be obtained from Franklin Industrial Minerals of 612 Tenth Avenue North, Nashville, Tenn. 37203.

Calcium carbonate, talc and fly ash filler increase the weight of the product, but utilization of prefabricated microspheres, such as glass and ceramic microspheres, enables the manufacture of a product with reduced weight and increased fire resistant properties. Clay may impart to the product the following nonlimiting characteristics: (1) lower heat build-up, (2) heat reflectance properties, (3) fire barrier properties, (4) no weight loss when exposed to heat and open flame, and (5) reduced disintegration when exposed to heat and open flame. Decabromodiphenyloxide and antimony trioxide impart the following nonlimiting characteristics: (1) flame retardant properties, (2) capability of forming a char, and (3) capability of stopping the spread of flames. It is believed that the gas produced from the heating of the decabromodiphenyloxide can also act as a flame retardant because the gas uses up oxygen or depletes oxygen and suppresses or stops the fire from further progression.

The prefabricated microcell component of the present invention is a component that is a hollow sphere or is capable of forming a hollow sphere and which has been constructed or manufactured before being employed in the present invention. Nonlimiting examples of the prefabricated microcells of the present invention include G-3500 hollow microspheres available from Zeelan Industries (St. Paul, Minn.), Expancel WV, Expancel DV, Expancel MB, Expancel WE and Expancel DE (polymer shells, all available from AKZO NOBEL, Duluth, Ga.), glass microspheres (K1, K15, S15, S22, K20, K25, S32, S60 AND K46, available from Zeelan Industries), ceramic microspheres (G3500, G3400, W1000, W1012, W1300 and W1600; available from Zeelan Industries), and Zeeospheres (G200, G850, W410 and W160; available from Zeelan Industries). In one embodiment of the invention, the prefabricated microcells are G3500 ceramic microspheres. FIG. 1 and FIG. 2 show prefabricated microcells of two exemplary embodiments of the invention. Glass microspheres are 2.5 times lighter than ceramic microspheres. Glass and ceramic microspheres can withstand heat greater than 2000° F. Also, glass and ceramic microspheres increase compressive strength, absorb no latex and/or water and thus permit the faster drying of the product. Glass and ceramic microspheres may also increase product flexibility.

The prefabricated microcells of the present invention may help to increase the pot life of the coating. Heavier particles in the fillers, although they may comprise but a small percentage of the particles in the filler, have a tendency to settle near the bottom of a storage vessel. When prefabricated microcells are mixed together with another filler, a dispersion is produced which has an increased pot life or shelf life. Without wishing to be bound by any particular theory, it is believed that as the filler particles naturally fall in the vessel and the prefabricated microcells rise, the smaller size filler particles are supported by the prefabricated microcells, thus enabling the microcells to stay in solution and preventing the filler particles, to at least some extent, from descending to the bottom of the vessel.

The first layer of the composite material of the present invention is prepared by using a binder component such as a high performance heat-reactive acrylic latex polymer and/or a non-heat reactive styrene butadiene latex to bond the filler materials together. Where the first layer is adhered to a substrate, the binder component may also act to bond the filler to the substrate. Nonlimiting examples of the binder component include Rhoplex 3349 (available from Rohm and Haas, Philadelphia, Pa.), Rovene 4402 (Mallard Creek Polymers, Inc., Akron, Ohio), Hycar™ 26469, Hycar™ 26472, Hycar™ 26484, Hycar™ 26497, Hycar™ 264552, Hycar™ 264512, Hycar™ 264582, Hycar™ 26083 (low formaldehyde), Hycar™ 9201 (low formaldehyde), Hycar™ 1552 (nitrile), Hycar™ 1571 (nitrile), Vycar™ 552, Hycar™ 2679 acrylic latex polymer (all Hycar™ and Vycar™ products are supplied by B.F. Goodrich Company of Cleveland, Ohio). Binder components may also include Cymel™ 373 (available from American Cyanamid), RHOPLEX™ TR 407 and R&H GL-618 latex both available from Rohm & Haas, and Borden FG-413F UF resin (available from Borden). It is believed, however, that any linear polymer, linear copolymer or branched polymer may be useful in preparing the first layer, such as those available from BASF and Goodyear. Further possible binder material include butyl rubber latex, SBR latex, neoprene latex, polyvinyl alcohol emulsion, SBS latex, water based polyurethane emulsions and elastomers, vinyl chloride copolymers, nitrile rubbers and polyvinyl acetate copolymers. In a preferred embodiment, an SBR latex is used. SBR latex adds good softness characteristics but is not a flame retardant. To improve fire resistance, an acrylic latex may be added or substituted. The more acrylic latex, the better the fire resistance of the material. However, softness is decreased when acrylic latex is substituted for the SBR late. In a preferred embodiment, the binder is Hycar 2679.

The surfactant component of the present invention may be any surfactant capable of forming microcells. In a preferred embodiment, the surfactant comprises a fast soap, such as ammonium lauryl sulfate (ALS), (e.g. Stepanol AM; Stepan Chemicals, Northfield, Ill.) and sodium lauryl sulfate (SLS). However, other surfactants may also be used which are not characterized as fast soaps but which are capable of forming microcells. Generally, a “fast soap” is a soap which is capable of efficiently modifying the surface tension of a solvent, such as water. However, other surfactants may also be used which are not characterized as fast soaps but which are capable of forming microcells. Fast soaps, such as ALS, form microcells that are resilient and are generally stable to the heat of processing. Additional components may be added to further stabilize the microcells, as further discussed below. However, if so desired, a surfactant which forms “weak” microcells may be used. The “weak” microcells may burst during processing to produce a less flexible fire resistant material.

When a surfactant is used to introduce surfactant-generated microcells, the first layer of the structural material may be made by combining the binder component, the prefabricated microcell component, a surfactant component and the filler component together and creating surfactant-generated microcells by any means known in the art, such as, but not limited to, blowing air into the mixture, agitation or by a foamer. In addition, chemical blowing agents, such as azo compounds, which release nitrogen gas, may be used to introduce surfactant-generated microcells.

In one embodiment of the invention, the mixture of the first layer is subjected to a roamer. The foamer acts to inject air into the mixture so that the surfactant forms surfactant-generated microcells within the mixture. The foamer may comprise a tube-like component having a multitude of pins which are capable of rotating in opposing directions (e.g. some pins move clockwise and some move counterclockwise). The mixture of binder, surfactant and filler is added to the foamer through a port on one side and, as it passes through the roamer, the pins rotate causing the surfactant to form microcells. Additional air may also be introduced into the foamer at another port. After having been subjected to the roamer, the mixture may then be applied onto a substrate, such as a fiberglass mat. Alternatively, the mixture may be applied onto a receiving platform, such as a steel tray. Whether applied to a substrate or a receiving platform, the material is then subjected to heat in an oven. Processing temperatures are preferably between about 280° F. and about 350° F. The prefabricated and surfactant-generated microcells are stable to the heat of processing. Generally, surfactant-generated microcells are not stable at temperatures above 350° F. Preferably, the surfactant generated microcells are relatively small and uniform in size.

In one embodiment of the present invention, the heat of processing is necessary for a hollow sphere microcell to form from a prefabricated microcell. In such an embodiment, the prefabricated microcell is in a collapsed state prior to heating and upon heating expands to form the hollow sphere microcell. Collapsed microcells may be prepared using a surfactant capable of forming microcells but which does not efficiently modify the surface tension of water. During the heat of processing, the surfactant-generated microcells expand, due to the expansion of gases within them, then burst and collapse. Accordingly the composite materials of the present invention may comprise collapsed microceils. The inclusion of collapsed microcells produces a composite material that is less flexible. Examples of prefabricated microcells which require heat to form a hollow sphere include the Expancel microcells listed above.

In another embodiment, the first layer of the composite material also includes a surfactant capable of regulating surfactant-generated microcell formation. One such surfactant is Stanfex 320 (Parachem, Dalton, Ga.). The surfactant capable of regulating microcell formation can ensure that the microcells remain within a preferred size range (e.g. do not get too big) and form in a relatively monodisperse state (i.e., are of the same general size). In a preferred embodiment, the microcells are about 5.0μ to about 20.0μ in diameter. In addition, citric acid may be used to ensure that the microcells are spread out uniformly.

It may also be desirable for the first layer of the composite materials to include a dispersant which acts to keep the mixture comprising the binder, surfactant and filler well dispersed during the material making process. Examples of such dispersants include, inter alia, TSPP, Accum 9300, Accum 9400 and Accum 9000 (all available from Rohm & Haas).

The second layer comprising the metallic component may be adhered to the first layer by any means known in the art. In a preferred embodiment, the metallic component is aluminum foil and is applied to the first layer while the first layer is still wet. When the material is subjected to the heat of an oven to dry the first layer, an adhesive bond is formed between the dried first layer and the aluminum foil.

The composite materials of the present invention are flexible and pliable. In addition they are durable and preferably do not crack upon bending. Durability of the composite materials may be enhanced by adding components capable of stabilizing the surfactant-generated microcells. Such components include surfactants such as ammonium stearate, octosol A18 (Tiarco Chemicals, Dalton, Ga.), A-1 (disodium n-alkylsulfosuccinate; Tiarco Chemicals), 449 (Parachem), and Stanfex 320. The microcell may be stabilized by making the wall of the microcell thicker. A surfactant, which comprises a long waxy chain, may be particularly useful for stabilizing the surfactant-generated microcells. Is there any thing that can be done to improve durability/pliability/flexibility of the materials when the comprise the aluminum foil? Are there any metallic components that are preferred for improving these characteristics?

The first layer of the composite material may further include a cross-linking component, such as melamine (Borden Chemicals, Morganton, N.C.), and/or ammonium chloride. The cross-linking component is useful to improve durability and reduce cracking. In order to control the amount and rate of cross-linking, it may be desired to control the pH of the mixed components. For example, in acidic conditions (pH˜4.0), the cross-linking will occur very quickly and the mixture will have a short pot-life. At higher pH (˜10.0), the cross-linking proceeds more slowly and can be controlled by heat.

The first layer of the composite material of the present invention may also comprise resin, which may provide a polymer shell to encapsulate air. In one embodiment, the resin is DPG-38, available from Parachem of Dalton, Ga.

In a preferred embodiment, the first layer of the composite material further possesses “bounce back” characteristics. As used herein, “bounce back” refers to the ability of the material to return to its original shape after having been distorted, such as stretched or compressed. In such an embodiment, additional components are added to achieve such bounce back characteristics. These components may coat the inside of the surfactant-generated microcell such that the microcell reverts to its original shape after having been distorted. Preferred components useful for achieving bounce back characteristics include CT101 (silicon oil, Kelmar Industries, Duncan, S.C.), Freepel 1225 (BF Goodrich, Cleveland, Ohio), Sequapel 409 (Omnovasolutions, Chester, S.C.), Michem emulsion 41740 (Michelman Inc., Cincinnati, Ohio), Syloff-1171A (Dow Corning Corp., Midland, Mich.), Syloff-62 (Dow Corning), Syloff-7910 (Dow Corning) and Aurapel 391 (Sybron/Tanatex, Norwich Conn.). These components also ensure that the microcells do not aggregate and form clumps of microcells.

The substrate of the present invention may be any suitable reinforcement material capable of withstanding processing temperatures, such as glass fibers, polyester fibers, cellulosic fibers, asbestos, steel fibers, alumina fibers, ceramic fibers, nylon fibers, graphite fibers, wool fibers, boron fibers, carbon fibers, jute fibers, polyolefin fibers, polystyrene fibers, acrylic fibers, phenolformaldehyde resin fibers, aromatic and aliphatic polyamide fibers, polyacrylamide fibers, polyacrylimide fibers or mixtures thereof which may include bicomponent fibers. The substrate provides strength for the composite material.

Examples of substrates in accordance with the invention include, inter alia, glass, fiberglass, ceramics, graphite (carbon), PBI (polybenzimidazole), PTFE, polyaramides, such as KEVLAR™ and NOMEX™, metals including metal wire or mesh, polyolefins such as TYVEK™, polyesters such as DACRON™ or REEMAY™, polyamides, polyimides, thermoplastics such as KYNAR™ and TEFZEL™, polyether sulfones, polyether imide, polyether ketones, novoloid phenolic fibers such as KYNOL™, KoSa™ polyester fibers, JM-137 M glass fibers, Owens-Corning M glass, Owens-Corning K glass fibers, Owens-Corning H glass fibers, Evanite 413M glass microfibers, Evanite 719 glass microfibers, cellulosic fibers, cotton, asbestos and other natural as well as synthetic fibers. The substrate may comprise a yarn, filament, monofilament or other fibrous material either as such or assembled as a textile, or any woven, non-woven, knitted, matted, felted, etc. material. The polyolefin may be polyvinyl alcohol, polypropylene, polyethylene, polyvinyl chloride, polyurethane, etc. alone or in combination with one another. The acrylics may be DYNEL, ACRILAN and/or ORLON. RHOPLEX AC-22 and RHOPLEX AC-507 are acrylic resins sold by Rohm and Haas which also may be used. The cellulosic fibers may be natural cellulose such as wood pulp, newsprint, Kraft pulp and cotton and/or chemically processed cellulose such as rayon and/or lyocell.

Examples of woven materials that may be useful in the present invention include continuous fiberglass veils, such as Pearlveil™ 110, Pearlveil™ 210, Curveil™ 120, Curveil™ 220, Flexiveil™ 130, Flexiveil™ 230 and Pultrudable veil (all available from Schmelzer Industries, Inc., Somerset, Ohio). The non-woven materials may be Airlaid™ (Precision Fabrics Group, N.C.) and Spunbond™ (Freudenberg Non-Woven, N.C.). Nonlimiting examples of filament materials include C, DE, G, H, K, M filaments (glass fiber filaments of differing thicknesses) of various grades, including electrical grade, chemical grade and high strength grade (all available from BFG Industries, Inc. of Greensboro, N.C.). As used herein, a fiberglass mat includes nonwoven and woven fiberglass mats. In one embodiment, the substate is a non-woven fiberglass mat which comprises from about 70-95% H glass filaments, from about 0-5% Evanite microglass at 4.5 microns, from about 0-15% polyester fiber (50/50 mix of ¼ inch and ½ inch length), and from about 5-10% acrylic based binder with a glass transition temperature (Tg) at 18° F.

In a particularly preferred embodiment, the substrate of the present invention is a woven fiberglass mat such as style 1625, style 1091 and style 1614 of BGF Industries (Greensboro, N.C.).

The composite materials of the present invention may be employed to make heat insulating, fire resistant building materials. Such building materials may be prepared during the building materials making process to include the composite materials of the present invention, or the composite materials may be utilized after building materials have already been installed. The composite materials may be used on their own or in conjunction with (e.g. as a liner for) other materials. For example, they may be applied to a structural article, such as building materials (e.g. gypsum board and siding materials, including sheathing) to obtain a heat insulating, fire resistant structural article. Such a structural article is useful for providing effective fire walls in buildings, including homes, and can provide a greater escape time and reduced heat exposure for the occupants of the building. In addition, the composite materials of the present invention may be applied to attic ceilings. The composite materials may be used to surface a roof prior to the application of roofing materials, or they may comprise part of a roofing material.

The composite materials may further be used to impart heat insulation and fire resistance to other objects, such as motor vehicles, trains, aircrafts, space ships, heating units, air conditioners, washing machines, dryers, furniture, mattresses and any other objects for which heat insulating and fire resistance properties are desired, such as upholstered articles, bedroom articles, (including children's bedroom articles), draperies, carpets, tents, awnings, fire shelters, sleeping bags, ironing board covers, barbecue grill covers, fire resistant gloves, airplane seats, engine liners, and fire-resistant clothing for race car drivers, fire fighters, jet fighter pilots, astronauts, facing sheets, building air duct liners, roofing underlayment (or roofing felt), underlayment for organic, built up roofing materials, roll roofing, modified roll products, filter media (including automotive filters), automotive hood liners, head liners, fire walls, vapor barriers etc. The use of the composite materials of the present invention in articles may enable the articles to exceed current flammability standards.

Composite materials made in accordance with this invention may be of any shape. Preferably, such articles are planar in shape. The composite materials of the present invention are flexible and pliable. In addition they are durable and preferably do not crack upon bending.

In making the composite material, a planar substrate may be coated on one side or both sides depending on the intended application. As used herein, “coated on one side or both sides” means that the coating coats at least a part of one side or at least a part of both sides of the substrate. For instance, if one side of the substrate is coated with the filler/binder coating, the other surface may be coated with another material. In the roofing materials industry, for example, the other material may be conventional roofing asphalt, modified asphalts and non-asphaltic coatings, and the article may then be topped with roofing granules. It is believed that such roofing material could be lighter in weight, offer better fire resistance and better performance characteristics (such as cold weather flexibility, dimensional stability and strength) than prior art roofing materials.

Additionally, the composite material may be coated with a water repellent material or the water repellant material may be added in the coating (i.e. internal water proofing). Two such water repellant materials are Aurapel™ 330R and Aurapel™ available from Sybron/Tanatex of Norwich, Conn. In addition, Omnova Sequapel™ and Sequapel 417 (available from Omnovasolutions, Inc. of Chester, S.C.); BS-1306, BS-15 and BS-29A (available from Wacker of Adrian, Mich.); Syl-ff™-7922, Syl-off™-1171A, Syl-off™-7910 and Dow Corning 346 Emulsion (available from Dow Corning, Corporation of Midland, Mich.); Freepel™-1225 (available from BFG Industries of Charlotte, N.C.); and Michem™ Emulsion-41740 and Michem™ Emulsion-03230 (available from Michelman, Inc. of Cincinnati, Ohio) may also be used. It is believed that wax emulsions, oil emulsions, silicone emulsions, polyolefin emulsions and sulfonyls as well as other similar performing products may also be suitable water repellant materials.

A defoamer may also be added to the coating of the present invention to reduce and/or eliminate foaming during production. One such defoamer is Drew Plus Y-250 available from Drews Inductrial Division of Boonton, N.J. In addition, ionic materials may be added to increase the ionic charge of the coating, such as ammonium hydroxide, Natrosol-NEC™ available from Hercules of Wilmington, Del.) and ASE-95NP and ASE-60 (available from Rohm & Haas of Charlotte, N.C.).

Fire retardant materials may also be added to the first layer of the composite materials of the present invention to further improve the fire resistance characteristics. Nonlimiting examples of fire retardant materials which may be used in accordance with the present invention include FRD-004 (decabromodiphenyloxide; Tiarco Chemiclas, Dalton, Ga.), FRD-01, FR-10, FR-11, FR-12, FR-13, FR-14 (all available from Tiarco Chemicals), zinc oxide, and aluminum trihydrate (ATH).

Further, heat insulating and fire resistant composite materials made in accordance with the invention may be coated with an algaecide such as zinc powder, copper oxide powder or the herbicides Atrazine available from e.g. Ribelin Inductries or Diuron avaibable from e.g. Olin Corporation, and antifungal material such as Micro-Chek™ 11P, an antibacterial material such as Micro-Check™ 11-S-160, a surface friction agent such as Byk™-375, a flame retardant material such as ATH (aluminum trihydrate) available from e.g. Akzo Chemicals and antimony trioxide available from e.g. Laurel Inductries. In addition, color pigments, including, but not limited to, T-113 (Abco, Inc.), W-4123 Blue Pigment, W2090 Orange Pigment, W7717 Black Pigment and W6013 Green Pigment, iron oxide red pigments (available from Engelhard of Louisville, Ky.) may also be added to the coating of the present invention to impact desired characteristics, such as a desired color. The Micro-Chek™ products are available from the Ferro Corporation of Walton Hills, Ohio. Byk-375 may be obtained from Wacker Silicone Corporation of Adrian, Mich. and T-1133A is sold by Abco Enterprises Inc. of Allegan, Mich.

The additional coatings of e.g. water repellant material, antifungal material, antibacterial material, etc., may be applied to one or both sides of composite materials otherwise having filler/binder coating on one of both sides of the substrate. For example, heat insulating, fire resistant composite materials comprising substrates coated on one or both sides with filer/binder coatings could be coated on one side with a water repellant composition and on the other side with an antibacterial agent. Alternatively, the water repellant material, antifungal material, antibacterial material, etc., may be added to the coating before it is used to coat the substrate.

As indicated, the heat insulating, fire resistant composite structural material of the present invention is useful in the manufacture of mattresses, particularly mattress borders. In mattress border embodiments, the composite structural material is placed either directly beneath the outer ticking layer or beneath a foam layer (preferably ¼″ polyurethane foam) that is itself beneath the ticking layer. In this embodiment, the composite material may be used to line a decorative mattress fabric to produce a heat insulating, fire resistant mattress fabric. Nonlimiting examples of mattress fabrics include ticking (known in the art as a strong, tightly woven fabric comprising cotton or linen and used especially to make mattresses and pillow covering), or fabrics comprising fibers selected from the group consisting of cotton, polyester, rayon, polypropylene, and combinations thereof. The lining may be achieved by methods known in the art. For example, the composite material of the present invention may simply be placed under a mattress fabric. Or, the heat insulating, fire resistant composite material may be bonded or adhered to the mattress fabric, for example using a flexible and preferably nonflammable glue or stitched with fire resistant thread i.e., similar to a lining, to make a heat insulating, fire resistant mattress fabric. The fire resistant mattress fabric of the present invention may then be used by the skilled artisan to manufacture a mattress product which has improved flammability characteristics.

Further materials which may be incorporated into the mattress products, particularly mattress borders, include construction materials, such as non fire retardant or fire retardant thread for stitching the mattress materials together (e.g. glass thread or Kevlar thread) and non-fire retardant or fire retardant tape. Silicon may be used with Kevlar thread to diminish breakage and enhance production time.

Fire resistant composite materials made in accordance with the present invention may be used in conjunction with foamed heat insulating materials made by any of the known methods for making foamed compositions such as, for example, aeration by mechanical mixing and the other techniques described in U.S. Pat. No. 5,110,839.

The composite materials of the present invention may be used to produce materials with characteristics similar to foam and cushion layers used in mattresses and may replace or be added in addition to such layers. In such embodiments, the foam and cushioning layers made with the heat insulating, fire resistant structural materials of the present invention impart heat insulation and fire resistance characteristics to the mattress when used therein.

Table I below provides, in approximate percentages, the components of the first layer of the structural material that the applicants believe would be useful in a preferred embodiment of composite material of the invention.

TABLE I

| | |
|---|---|
| Coating Components | % Wet |

BINDER

| | |
|---|---|
| Hycar 2679 | 25.00 |

FILLER

| | |
|---|---|
| FRD-004 | 27.26 |

PREFABRICATED MICROCELLS

| | |
|---|---|
| G-3500 | 18.00 |

CROSS-LINKER

| | |
|---|---|
| Melamine | 5.00 |

MISCELLANEOUS

| | |
|---|---|
| Water | 25.74 |
| Total Percentage | 100.00% |

SUBSTRATE = BGF Industries Style 1625 fiberglass mat.

Although the table shows possible combinations of binder, filler and prefabricated microcells, it is believed that other combinations may be employed.

The composite materials, as mentioned, may include a substrate and a first layer, which comprises a prefabricated microcells component, a surfactant component, surfactant-generated microcells, a filler component and a binder component. The first layer of the material comprises approximately 34% by weight of the heat insulating, fire resistant composite material. In the first layer, about 10% to about 55% by weight is binder, about 2% to about 45% is prefabricated microcells, and from about 2% to about 45% is filler. In a preferred embodiment, the coating comprises about 25% binder, about 18% prefabricated microcells and about 18% filler (clay) and the remainder is water. The substrate is preferably woven glass. The substrate is approximately 66% by weight of the heat insulating, fire resistant composite material. The binder which bonds together the glass fibers is approximately about 25% to about 55% B.F. Goodrich 2679 Acrylic Latex. Any suitable binder may be used, including those listed herein above. The second layer is preferably aluminum foil and is approximately 0.5% to 1.5% by weight of the heat composite material, depending on whether one or two layers of foil are employed.

In the inventive heat insulating, fire resistant composite materials, the substrate may be coated with the first layer by air spraying, dip coating, knife coating, roll coating or film application such as lamination/heat pressing. The first layer may be bonded to the substrate by chemical bonding, mechanical bonding and/or thermal bonding. Mechanical bonding is achieved by force feeding the first layer onto the substrate with a knife. The second layer comprising the metallic component may be adhered to the first layer by any means known in the art, including chemical bonding (e.g. with adhesives) and mechanical bonding.

The mixture comprising the first layer which comprises binder component, the prefabricated microcell component and the filler component may have a consistency of a light foam, such as shaving cream. It is believed that due to the low density of the mixture, the microcells do not pass through the substrate when applied thereto. Moreover, the viscosity of the coating can be increased through mixing to ensure that it does not bleed through the substrate. Nonlimiting examples of thickening agents include Acrysol ASE-95NP, Acrysol ASE-60, Acrysol ASE-1000, Rhoplex ASE-75, Rhoplex ASE-108NP, and Rhoplex E-1961, all available from Rohm & Haas.

Additionally, the first layer of the composite material may be coated with a water repellent material or the water repellent material may be added in the first layer (i.e., internal water proofing). Two such water repellent materials are Aurapel™ 330R and Aurapel™ 391 available from Sybron/Tanatex of Norwich, Conn. In addition, Omnova Sequapel™ and Sequapel 417 (available from Omnovasolutions, Inc. of Chester, S.C.); BS-1306, BS-15 and BS-29A (available from Wacker of Adrian, Mich.); Syl-off™-7922, Syl-off™-1171A, Syl-off™-7910 and Dow Corning 346 Emulsion (available from Dow Corning, Corporation of Midland, Mich.); Freepel™-1225 (available from BFG Industries of Charlotte, N.C.); and Michem™ Emulsion-41740 and Michem™ Emulsion-03230 (available from Michelman, Inc. of Cincinnati, Ohio) may also be used. It is believed that wax emulsions, oil emulsions, silicone emulsions, polyolefin emulsions and sulfonyls as well as other similar performing products may also be suitable water repellent materials. As indicated above, these materials are also useful for imparting bounce back characteristics to the composite materials of the present invention. Water repellents may be particularly preferred for example, in the manufacture of building materials, crib mattresses, airplane seats and in the manufacture of furniture, particularly for industrial use.

A defoamer may also be added to the first layer of the present invention to reduce and/or eliminate foaming during production. One such defoamer is Y-250 available from Drews Industrial Division of Boonton, N.J.

Fire retardant materials may also be added to the first layer of the composite materials of the present invention to further improve the fire resistance characteristics. Nonlimiting examples of fire retardant materials which may be used in accordance with the present invention include FRD-004 (decabromodiphenyloxide; Tiarco Chemicals, Dalton, Ga.), FRD-01, FR-10, FR-11, FR-12, FR-13, FR-14 (all available from Tiarco Chemicals) zinc oxide, and ATH.

In addition, color pigments, including, but not limited to, T-113 (Abco, Inc.), W-4123 Blue Pigment, W2090 Orange Pigment, W7717 Black Pigment and W6013 Green Pigment, iron oxide red pigments (available from Engelhard of Louisville, Ky.) may also be added to the first layer of the present invention to impart desired color characteristics.

The additional coatings of, e.g. water repellent material, antifungal material, antibacterial material, etc., may be applied to one or both sides of the composite materials, preferably between the first layer and the second layer comprising the metallic component. For example, composite materials comprising substrates covered on one or both sides with the first layer coatings could be coated on one side with a water repellent composition and on the other side with an antibacterial agent beneath the second layer comprising the metallic component. The second layer comprising the metallic component may be adhered to one or both sides of the structural material. Alternatively, the water repellent material, antifungal material, antibacterial material, etc., may be added to the first layer before it is adhered to the substrate.

It should be understood that compositions other than those described above may be used while utilizing the principles underlying the present invention. For example, other sources of filler as well as mixtures of acrylic latex and/or surfactants and metallic components may be used in formulating the structural materials of the present invention. Moreover, the coating compositions may be applied to various types of substrates, as described above.

What is claimed is:

1. A composite material comprising:
(a) a first layer which comprises a prefabricated microcells component, a surfactant component, surfactant-generated microcells, a filler component and a binder component; and
(b) a second layer comprising a metallic component adhered to the first layer.

2. A composite material comprising:
(a) a substrate;
(b) a first layer adhered to the substrate to provide a coated substrate, said first layer comprising a prefabricated microcells component, a surfactant component, surfactant-generated microcells, a filler component and a binder component; and
(c) a second layer comprising a metallic component adhered to the coated substrate.

3. The composite material according to claim 2, wherein said substrate is planar and said first layer is adhered to one side of the substrate.

4. The composite material according to claim 2, wherein said substrate is planar and said first layer is adhered to both sides of the substrate.

5. The composite material according to claims 3 or 4 wherein said second layer is adhered to one side of said coated substrate.

6. The composite material according to claims 3 or 4 wherein said second layer is adhered to both sides of said coated substrate.

7. The composite material according to claim 1, wherein said first layer is planar and the second layer is adhered to one side of the first layer.

8. The composite material of claim 1, wherein the first layer is planar and the second layer is adhered to both sides of the first layer.

9. The composite material according to claims 1 or 2 wherein said composite material further includes a water repellent material.

10. The composite material according to claims 1 or 2 wherein said composite material further includes an antifungal material.

11. The composite material according to claims 1 or 2 wherein said composite material further includes an antibacterial material.

12. The composite material according to claims 1 or 2 wherein said composite material further includes a surface friction agent.

13. The composite material according to claims 1 or 2 wherein said composite material further includes a flame retardant material.

14. The composite structural material according to claims 1 or 2 wherein said composite material further includes an algaecide.

15. The composite material according to claims 1 or 2 wherein said composite material is colored with dye.

16. The composite material according to claims 1 or 2, wherein the metallic component is selected from a group consisting of aluminum or stainless steel.

17. The material according to claim 16, wherein the metallic component is aluminum foil.

18. The composite material according to claims 1 or 2, wherein the filler component is clay.

19. The composite material according to claims 1 or 2, wherein the surfactant component is a fast soap.

20. The composite material according to claims 1 or 2, wherein the surfactant component forms surfactant-generated microcells.
